(19) United States
(12) Patent Application Publication
(10) Pub. No.: US 2005/0154679 A1
(43) Pub. Date: Jul. 14, 2005

(54) System for inserting interactive media within a presentation

(76) Inventor: Stanley Bielak, Annapolis, MD (US)

Correspondence Address: National IP Rights Center, LLC, Suite 400, 550 Township Line Road, Blue Bell, PA, 19422, US

(21) Appl. No.: 10/755,036

(22) Filed: Jan. 8, 2004

(51) Int. Cl. G06F 17/60

(52) U.S. Cl. 705/59

(57) ABSTRACT

A computer system for creating a presentation containing interactive media such as polls or quizzes comprising the following steps: taking a video stream including a plurality of video frames, each said video frame including a time stamp; and sequentially displaying said video frames on said display device, starting from an initial video frame of said video stream; adding additional placeholder slides corresponding to user polls, quizzes or website links accessible via a remote server; and uploading the presentation into the remote server which is accessible to end users.

### FIELD OF THE INVENTION

The present invention relates generally to an improved system which permits a computerized video presentation, alternatively, including a slide show presentation, to be modified and upgraded, and specifically to be upgraded to include quizzes, polling, links to URLs, user tracking and other levels of interactivity.

### BACKGROUND OF THE INVENTION

Computer application programs often have associated data files that are processed by the programs during their normal execution. A data file can contain information that is processed and presented to a user either in a video presentation or an audio presentation, or a combination of video and audio. A presentation program is one example of a computer application program that processes an associated data file for displaying a visual/audio presentation to the user. Presentation programs enable a user to create, edit, manage, and perform “presentations” such as a “slide show” with a computer. Two examples of a popular presentation program are “PowerPoint” and “Producer,” available from the “Microsoft Corporation,” of Redmond, Wash.

A slide show presentation includes a set of electronic “slides,” each slide corresponding to one screen or page of output. Each slide contains one or more objects, such as text, graphical images, or graphic automation. A slide may also include sound and video objects that are played when the slide is displayed during a “slide show” performance. A presentation program “performs” a slide show by sequentially displaying a series of slides contained within the slide show presentation. The slides are displayed on a computer screen or projected onto a separate surface. A “presenter” controls the presentation of the slide show by invoking a command that may “advance” to the next slide in the slide show or “return” to the previous slide. Other commands may cause the presentation to jump to a given slide (out of order) and/or play a sound. The commands may be customized so that the slide show is interactive with the user/presenter, e.g., a mouse click may be customized to animate a displayed object, play an audio sample or jump to another slide in the slide show presentation. Also, the commands may be entered with different types of user interface devices such as a keyboard, mouse, or touch screen display. It is envisioned that the presentation of the slide show can be viewed solely by the presenter, by individual users or displayed for a larger audience.

Alternatively, the author of a slide show presentation may include slide “timings” with each slide in the slide show that synchronize the slide show with an associated audio or video file. A slide timing corresponds to a slide and indicates the number of seconds that the slide will be displayed before the presentation program automatically advances to the next slide in the slide show. The slide show presentation will automatically advance to the next slide in the slide show when the existing slide's timing ends. The ordered sequence for presenting slides and “events” on those slides is predetermined by a slide show presentation author. Also, during a presentation of a slide show, the presenter may enter commands that alter the sequence for displaying the slides or cause different events to occur.

Typically, a presentation program enables a user to save a slide show in an associated slide presentation file, so that the slide show can be recreated at another location that has access to the presentation program and the slide presentation file. In the past, slide presentation files were often distributed on a storage medium that also contained at least a display only version of the presentation program for graphically displaying the slide show to a user with the information stored in the slide presentation file. The number and size of slide presentation files that can timely and economically be distributed in this manner is limited.

Microsoft permits audio and video movie files to be integrated into a computer operating system, e.g., the “Windows” operating system available from the “Microsoft Corporation.” Examples of standard movie file formats include “Windows Media “(”.wmv” files), available from “Microsoft Corporation” of Redmond, Wash., and “QuickTime” available from “Apple Computer, Inc.” Therefore, it is desirable to save the presentation of slides in a slide show as movie data in a movie file so that a movie of the slide show presentation may be displayed with any widely available application program capable of playing the movie file. It is also desirable to enable the user to interact with the slide show presentation.

More recently, Microsoft has developed tools such tools as Microsoft Producer which facilitates the creation and editing of video presentation. While there are a number of technologies for enabling the creation and editing of slideshows and video presentations, there are no systems which facilitate the automatic inclusion of features for interactive polling, quizzing URLs. In addition to Producer, there are alternative systems which substantially produce the same result, including Presentation Maker, Media Publisher Presenter One and Show and Tell.

It would be desirable to provide a system which would enable a presentation and authoring system for slide show and video presentations to include quizzes and polling. It would particularly desirable to provide a system whereby a presentation could be authored and hosted on a remote server. Additionally, it would be desirable if the author of the presentation could monitor how users viewed each presentation “who watched and how far did they get into the presentation.

It is therefore an object of the present invention to provide a system which permits a presentation and authoring system for slide show and video presentations to be edited to include quizzes, polling, and user tracking. It would particularly desirable to provide a system whereby a presentation could be authored and hosted on a remote server.

These and other objects of the present invention will be determined with reference to the claims appended hereto.

### SUMMARY OF THE INVENTION

A computer system for creating and deploying presentations containing interactive media such as polls or quizzes comprising the following steps taking a video stream including a plurality of video frames, each said video frame including a time stamp; and sequentially displaying said video frames on said display device, starting from an initial video frame of said video stream; adding additional placeholder slides corresponding to user polls, quizzes or website links accessible via a remote server; and uploading the presentation into the remote server which is then accessible to end users.

A method for playing a presentation including polls or quizzes comprising: receiving a presentation in from a remote server; sequentially playing the frames, starting from an initial frame of the stream of data; selecting from a table of contents being displayed on a display device of a local computer, content related to a poll or quiz to be accessed by the end user; communicating the request for poll or quiz to the remote server; receiving the stream of data from the server, related to the poll or quiz; responding to the poll or quiz at the local by the end user and uploading the poll or quiz results on the remote server.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a block diagram of an exemplary computer system for practicing the various aspects of the present invention.

FIG. 2 is a block diagram showing an exemplary hardware environment for practicing the annotated video-on-demand (VOD) system of the present invention.

FIG. 3 is shows a producer which includes a capture module and an author module.

FIG. 4a is a flowchart illustrating the capture of a live video/audio stream from a video camera or from a previously stored video file.

FIGS. 4b and 4c are flowcharts illustrating a locator annotation stream and a data annotation stream, respectively.

FIG. 5 shows an exemplary format for storing and delivering a compressed video stream.

FIG. 6 shows an exemplary customized LiveScreen display which includes a video window, a set of VCR-like control buttons, a selectable table of contents (TOC) and an HTML page window.

FIG. 7 illustrates an author tool provided by an author module for the designer to visually creating annotation streams.

FIGS. 8a and 8c are exemplary formats illustrating a locator annotation stream and a data annotation stream, respectively.

FIG. 9 illustrates one embodiment of the client computer which includes a web browser and a browser plug-in module for interfacing a web browser with a client module.

FIGS. 10a and 10b are flowcharts illustrating the operation of the client module.

FIG. 11 is a flowchart illustrating the use of a table of content with content labels enabling a viewer to skip forward or backward to predetermined locations in the video/audio stream.

FIG. 12 is a block design of the main components of the present invention for inputting interactive content into a slideshow/multimedia presentation.

FIGS. 13a and 13b illustrate the place holder slides of the present invention.

FIG. 14 illustrates the user interface in accordance with the present invention.

FIGS. 15a to 15f illustrate authoring screens in accordance with the present invention.

FIG. 16 is a flow diagram of the authoring process.

FIG. 17 is a diagram of the wrapper process.

FIGS. 18-20 illustrate the server/database and their operation.

### DETAILED DESCRIPTION OF THE PREFERRED EMBODIMENT

The present invention is directed to an improved system for creating links, polling and quizzes for multimedia presentations such as those which incorporate applicant's invention. The present invention as described in a first embodiment in the context of a system for creating and publishing multi-media presentations. Presentation programs, such as Microsoft “PowerPoint” and “Producer” typically include user interfaces for enabling users to create, edit, view and save slide show presentations.

Presentation programs have provided for saving slide show and movie presentations in proprietary file formats that were only recognized by the presentation programs. The presentation program saves transformed slide show presentation objects in a standard movie file format, such as “Windows Media”. Any that recognizes the format of the movie data in the movie file may be employed to play the movie file and display a movie of the slide show presentation. Thus, a movie that is representative of the slide show presentation may be viewed by a user that does not have access to the presentation program originally employed to create the slide show presentation.

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order to not unnecessarily obscure the present invention.

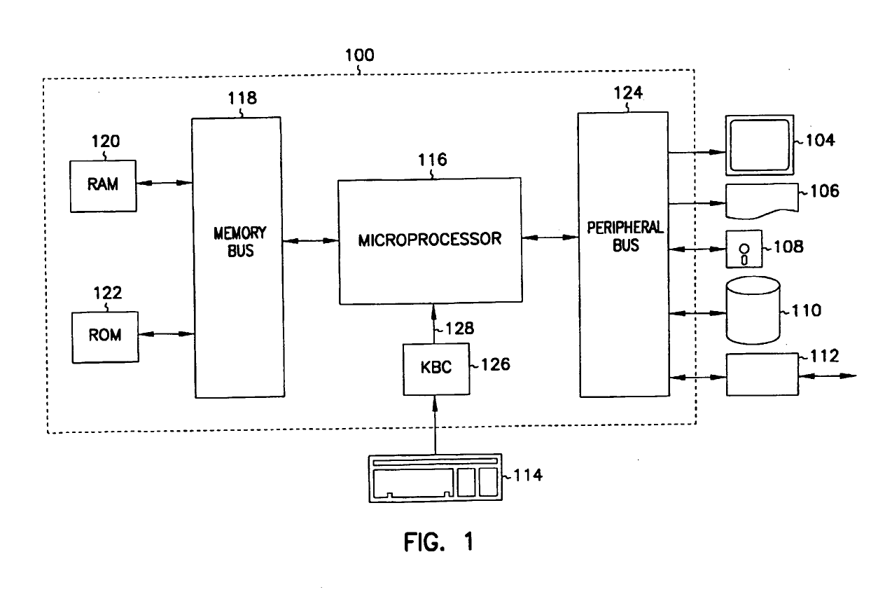

FIG. 1 is a block diagram of an exemplary computer system 100 for practicing the various aspects of the present invention. Computer system 100 includes a display screen (or monitor) 104, a printer 106, a floppy disk drive 108, a hard disk drive 110, a network interface 112, and a keyboard 114. Computer system 100 includes a microprocessor 116, a memory bus 118, random access memory (RAM) 120, read only memory (ROM) 122, a peripheral bus 124, and a keyboard controller 126. Computer system 100 can be a personal computer (such as an Apple computer, e.g., an Apple Macintosh, an IBM personal computer, or one of the compatibles thereof), a workstation computer (such as a Sun Microsystems or Hewlett-Packard workstation), or some other type of computer, a laptop, notebook, etc.

Microprocessor 116 is a general purpose digital processor which controls the operation of computer system 100. Microprocessor 116 can be a single-chip processor or can be implemented with multiple components. Using instructions retrieved from memory, microprocessor 116 controls the reception and manipulation of input data and the output and display of data on output devices.

Memory bus 118 is used by microprocessor 116 to access RAM 120 and ROM 122. RAM 120 is used by microprocessor 116 as a general storage area and as scratch-pad memory, and can also be used to store input data and processed data. ROM 122 can be used to store instructions or program code followed by microprocessor 116 as well as other data.

Peripheral bus 124 is used to access the input, output, and storage devices used by computer system 100. In the described embodiment(s), these devices include display screen 104, printer device 106, floppy disk drive 108, hard disk drive 110, and network interface 112. Keyboard controller 126 is used to receive input from keyboard 114 and send decoded symbols for each pressed key to microprocessor 116 over bus 128.

Display screen 104 is an output device that displays images of data provided by microprocessor 116 via peripheral bus 124 or provided by other components in computer system 100. Printer device 106 when operating as a printer provides an image on a sheet of paper or a similar surface. Other output devices such as a plotter, typesetter, etc. can be used in place of, or in addition to, printer device 106.

Floppy disk drive 108 and hard disk drive 110 can be used to store various types of data. Floppy disk drive 108 facilitates transporting such data to other computer systems, and hard disk drive 110 permits fast access to large amounts of stored data.

Microprocessor 116 together with an operating system operate to execute computer code and produce and use data. The computer code and data may reside on RAM 120, ROM 122, or hard disk drive 120. The computer code and data could also reside on a removable program medium and loaded or installed onto computer system 100 when needed. Removable program mediums include, for example, CD-ROM, PC-CARD, floppy disk and magnetic tape.

Network interface circuit 112 is used to send and receive data over a network connected to other computer systems. An interface card or similar device and appropriate software implemented by microprocessor 116 can be used to connect computer system 100 to an existing network and transfer data according to standard protocols.

Keyboard 114 is used by a user to input commands and other instructions to computer system 100. Other types of user input devices can also be used in conjunction with the present invention. For example, pointing devices such as a computer mouse, a track ball, a stylus, or a tablet can be used to manipulate a pointer on a screen of a general-purpose computer.

The present invention can also be embodied as computer readable code on a computer readable medium. The computer readable medium is any data storage device that can store data which can be thereafter be read by a computer system. Examples of the computer readable medium include read-only memory, random-access memory, magnetic data storage devices such as diskettes, and optical data storage devices such as CD-ROMs. The computer readable medium can also be distributed over a network coupled computer systems so that the computer readable code is stored and executed in a distributed fashion.

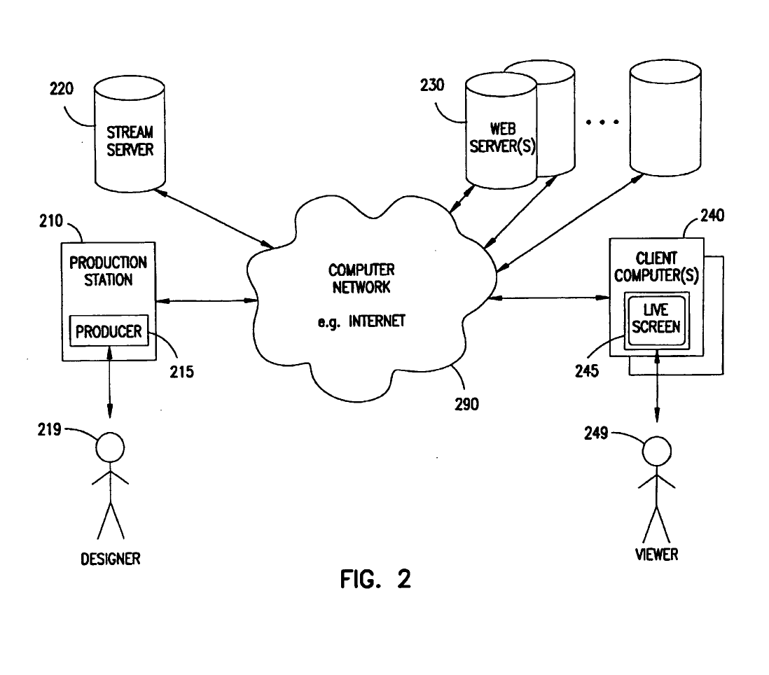

FIG. 2 is a block diagram showing an exemplary hardware environment for practicing on the annotated video-on-demand (VOD) system. The VOD system includes a production station 210, a stream server 220, at least one web server 230 and at least one client computer 240, each of which can be implemented using computer system 100 described above. Stream server 220 and web server 230 are coupled to client computer 240 via a computer network 290, e.g., the Internet. Note that the disclosed hardware environment is exemplary. For example, production station 210 and stream server 220 can be implemented using two separate computer systems or using one computer system. In addition, if production station 210 and stream server 220 are implemented on separate computer systems as shown in FIG. 2, an optional direct connection (not shown) between production station 210 and stream server 220 can provide faster uploads of compressed video and annotation streams. In the following description, an audio stream optionally accompanies each video stream.

A producer 215, installed in production station 210, is a user-friendly tool for use by a designer 219 to create a synchronization script which includes annotation stream(s). The annotation stream(s) define the content(s) of a LiveScreen display 245 to be displayed on client computer 240 for a viewer 249. LiveScreen 245 display provides a graphical user interface (GUI) with multiple windows for synchronously displaying a video stream from stream server 220 and at least one displayable event stream. Examples of displayable events include textual/graphical information such as HTML—scripted web page(s) from web server 230. As will be described herein, the improvements to the present invention permit the addition of polls and quizzes.

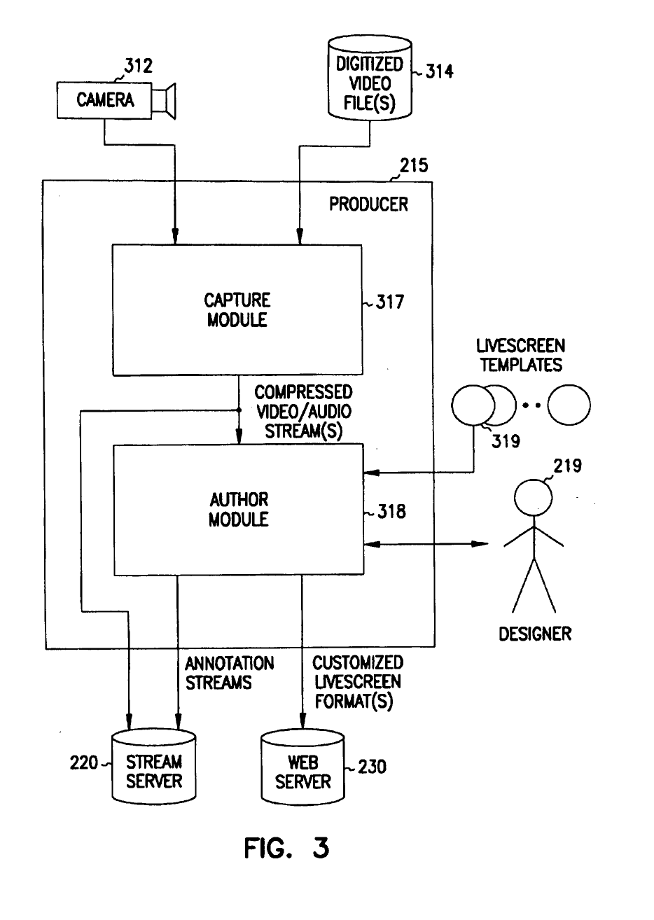

In one embodiment, as shown in FIG. 3, producer 215 includes a capture module 317 and an author module 318. Production station 210 includes 16 MB of RAM and a 1 GB hard disk drive for capturing and storing an uncompressed or compressed video stream. Sources for generating video streams include a video camera 312, a videocassette recorder (VCR) (not shown) or a previously digitized video file 314, e.g., a Windows Media (.wmv) file. For ease of installation and use by designer 219, producer 215 is implemented in a host environment which includes a window-based operating system such as Microsoft Windows 95, 98, NT, 2000, XP, etc. and a web browser such as Netscape's Navigator 3.x. or Internet Explorer (Appendix A is a detailed user manual for one implementation of producer 215).

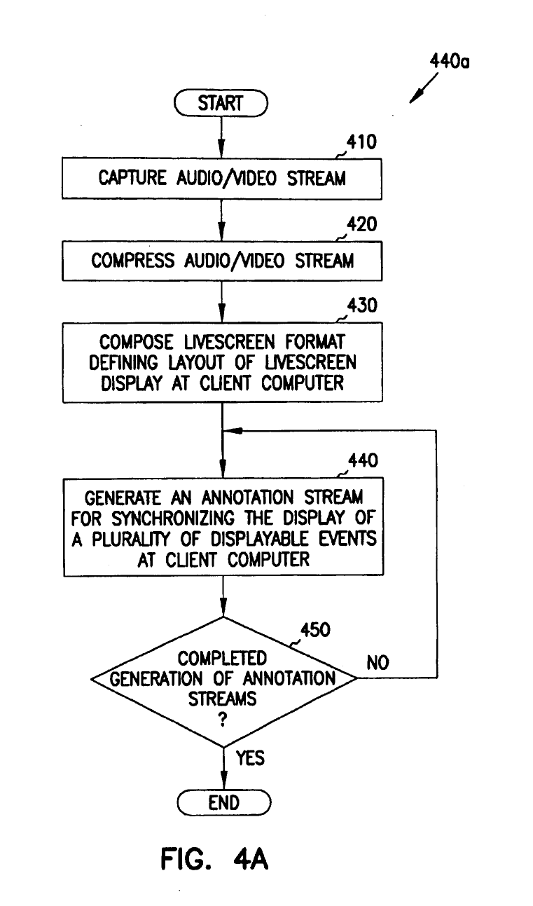

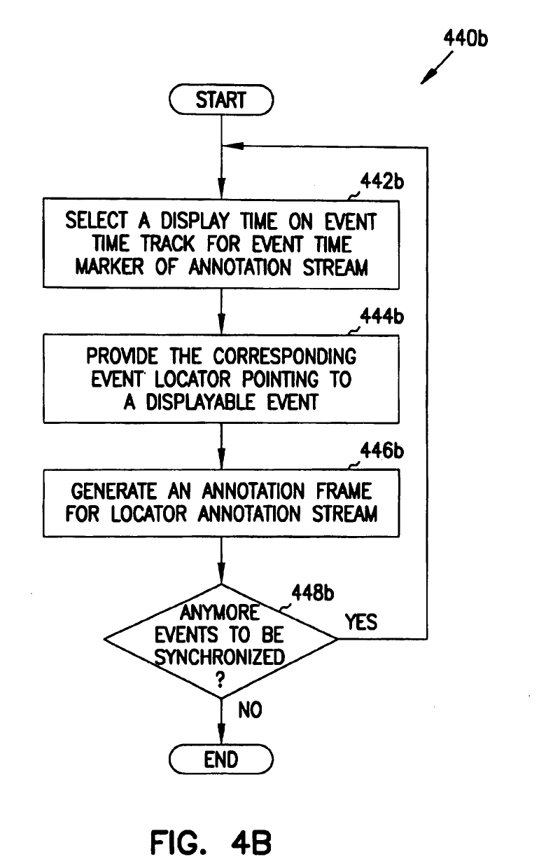

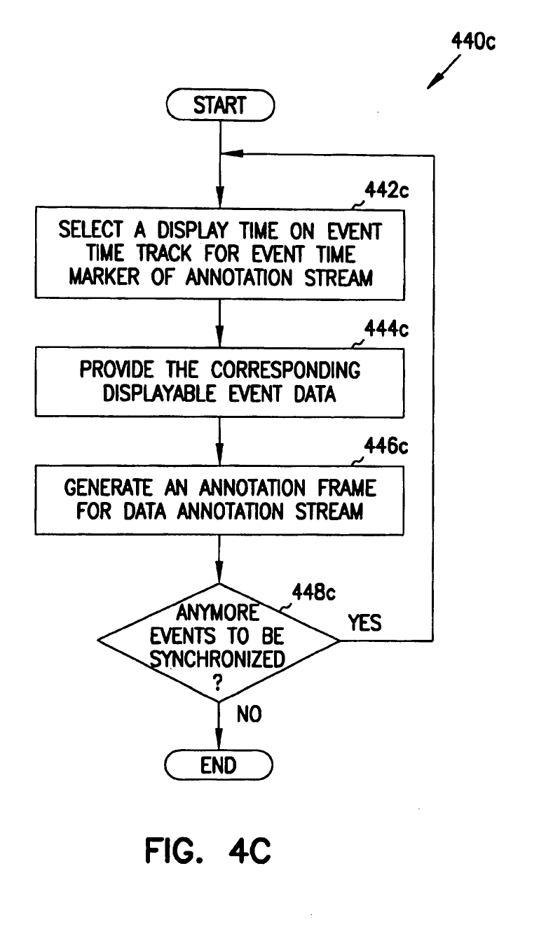

Referring also to the flowchart of FIG. 4a, in step 410 capture module 317 captures a live video/audio stream from video camera 312 or from the previously stored video file 314. If video camera 312 provides an analog video stream, e.g., an NTSC signal, a hardware capture card (not shown) provides the required conversion from the analog video stream to a digitized video stream. Because temporary storage of uncompressed video data is memory intensive, some form of pre-compression can be used to reduce the memory storage requirement of the input video stream during capture step 410 and prior to compression step 420.

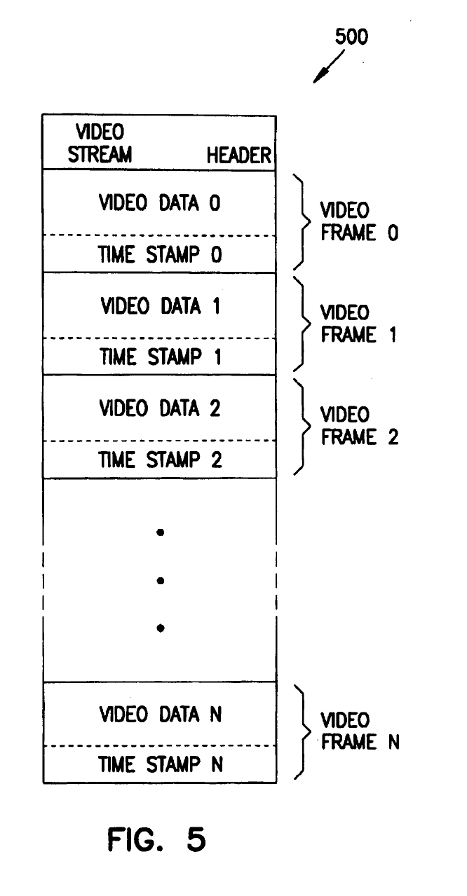

In step 420, capture module 420 compresses the digitized video stream using a suitable compression technique. In this embodiment, depending on the bandwidth capacity of the connection provided by network 290 between stream server 220 and client computer 240, e.g., a POTS modem, ISDN or Ethernet, a suitable frame resolution and frame rate combination is selected. A compression algorithm based on the H263 standard (see co-pending applications VXT 702 and 718) is used for compressing lower bandwidth video streams, e.g., at less than 56 kbps. Alternatively, a Vxpress format (see co-pending application VXT 712) is used for compressing higher bandwidth video streams. FIG. 5 shows an exemplary format 500 for storing and delivering a compressed video stream.

A similar format can also be used to store and deliver a separate compressed audio stream. It is also possible to combine, e.g., interleave a compressed video and audio data into one stream for delivery. Audio encoders/decoders (codecs) are available from a number of commercial sources. Examples include ToolVox from Voxware Inc., 305 College Road East, Princeton, N.J. 08540, and QCELP from QUALCOMM Inc., 10555 Sorrento Valley Road, San Diego, Calif. 92121.

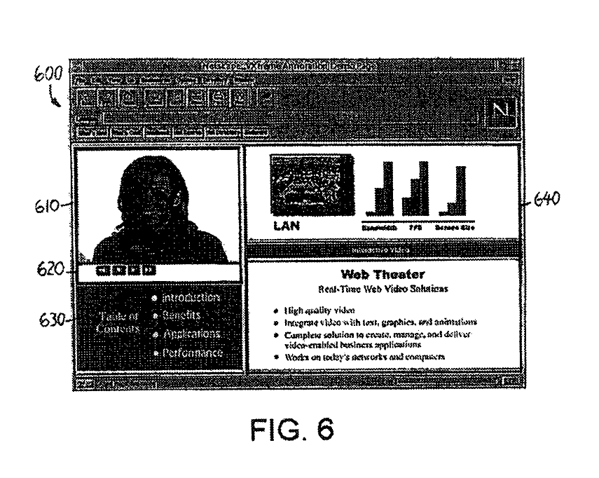

Referring back to FIGS. 3 and 4a, in step 430, designer 219 uses author module 318 to compose a suitable LiveScreen display format which defines the layout of LiveScreen display 245 at client computer 240. FIG. 6 shows an exemplary customized LiveScreen display 600 which includes a video window 610, a set of VCR-like control buttons 620, a selectable table of contents (TOC) 630 and an HTML page window 640. Examples of other displayable event windows include but is not limited to ticker tape windows (not shown). In this implementation, LiveScreen templates 319 are available for designer 219 to use as starting points for composing customized LiveScreen formats.

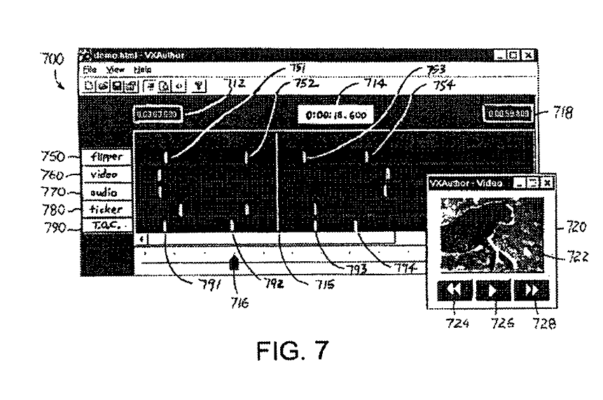

FIG. 7 illustrates an author tool 700 provided by author module 318 for designer 219 to visually creating annotation streams (step 440). There are two types of annotation streams. The first type of annotation streams are data annotation streams in which the displayable event data are embedded within the annotation streams. Examples of data annotation streams include ticker annotation streams which include ticker tape data embedded within the annotation stream. The second type of annotation streams are locator annotation streams in which the displayable data is either too cumbersome and/or is continually evolving to be embedded as static data within the annotation stream. Instead, event locator(s) pointing to the location of the displayable data are stored in the annotation streams instead of the displayable data. Examples include URL addresses pointing to HTML pages.

Designer 219 may view frames from video stream 500 displayed in video window 720 for referencing and selecting appropriate time stamps to use in generating annotation streams. Within video window 720, VCR function buttons, e.g., a rewind button 724, a play button 726 and a fast forward button 728, are available for designer 219 to quickly traverse video stream 500. Since video window 720 is provided as a convenience for designer 219, if designer 219 has prior knowledge of the content of the video stream, designer 219 may proceed with the generation of the annotation streams without viewing video window 720.

As shown in FIG. 7, author tool 700 displays a flipper time track 750, a video time track 760, an audio time track 770, a ticker time track 780 and a table of contents (TOC) time track 790. Flipper time track 750 and ticker time track 780 aid designer 217 in generating a flipper annotation stream and a ticker annotation stream, respectively. Another visual control aid, zoom bar 716, enables designer 219 to select the respective portions of the complete time tracks 750,760, 770, 780 and 790, as defined by start time indicator 712 and end time indicator 718, which is currently displayed by author tool 700.

In accordance with one aspect of the invention, annotation frames are generated by designer 217 to form customized annotation streams (step 440). A time hairline 715 spanning time tracks 750, 760, 770, 780 and 790 provides designer 217 with a visual aid to select an appropriate time, displayed in time indicator 714, for synchronizing a displayable event. The exemplary format of time indicators 712, 714 and 718 are “hours:minutes:seconds”.

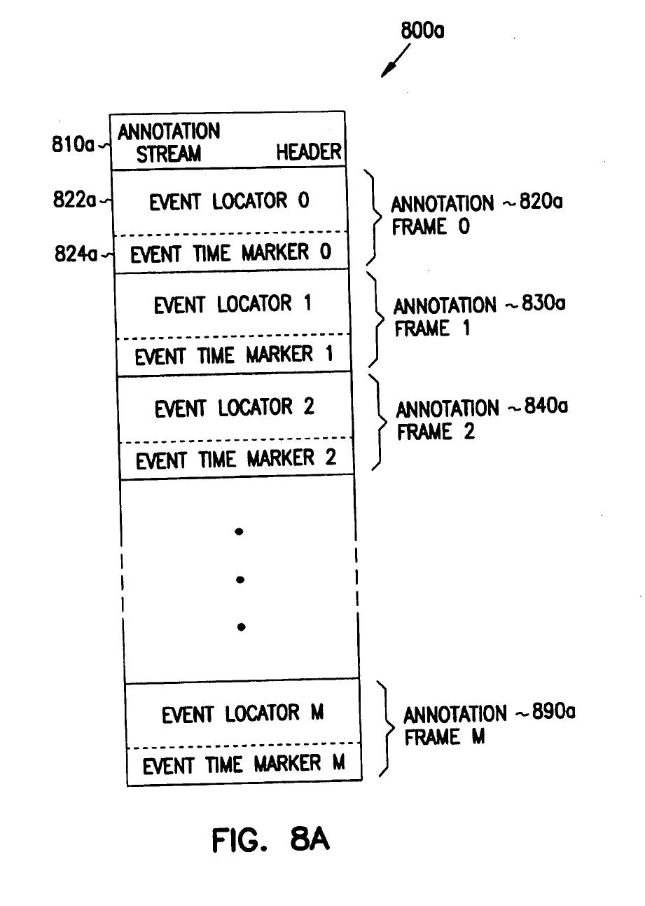

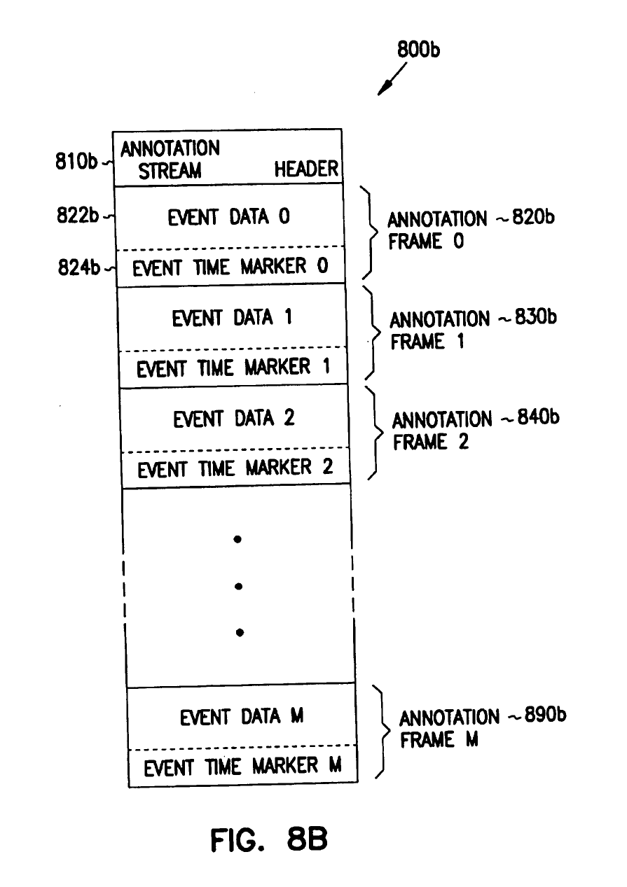

FIGS. 4b and 8a are a flowchart and an exemplary format, respectively, illustrating a locator annotation stream 800a. Locator annotation stream 800a includes an annotation stream header 810a, and a plurality of annotation frames 820a, 830a, 840a . . . 890a. Each annotation frame includes an event locator and an event time marker, e.g., annotation frame 820a includes event locator 822a and event time marker 824a. One example of a locator annotation stream is a flipper stream. Flipper time track 750 provides a convenient way to select suitable event time marker values, e.g., flipper time markers 751, 752, 753, 754, for the respective event locators. For example, URL addresses (event locators) pointing to HTML pages enable client computer 240 to subsequently retrieve textual and/or graphical elements to be displayed at predetermined time as defined by the time markers of the flipper stream.

FIGS. 4b and 8c are a flowchart and an exemplary format, respectively, illustrating a data annotation stream 800b. Locator annotation stream 800a includes an annotation stream header 810a, and a plurality of annotation frames 820a, 830a, 840a, . . . 890a. Each annotation frame includes an event locator and an event time marker, e.g., annotation frame 820a includes event locator 822a and event time marker 824a. One example of a data annotation stream is a ticker stream. The generation of the ticker stream is somewhat similar to that of the flipper stream. However, in the case of the ticker stream, instead of event locators, displayable data is embedded directly into the ticker stream as event data.

When author module 318 has completed building an annotation stream, e.g., the flipper stream, the annotation stream is given a file name and loaded into a convenient server, e.g., stream server 220, for subsequent retrieval by client computer 240. The use of the annotation streams is described in greater detail below with the description of client computer 240.

In accordance with another aspect of the invention, LiveScreen display 600 also includes a table of contents (TOC) 630, enabling viewer 249 at client computer 240 to skip forward or backward to a point within the entire video/audio stream 500. TOC 630 include one or more content labels, each indexed to a corresponding time stamp in video stream 500, as defined by TOC time markers 791, 792, 793, 794 in LiveScreen display 600.

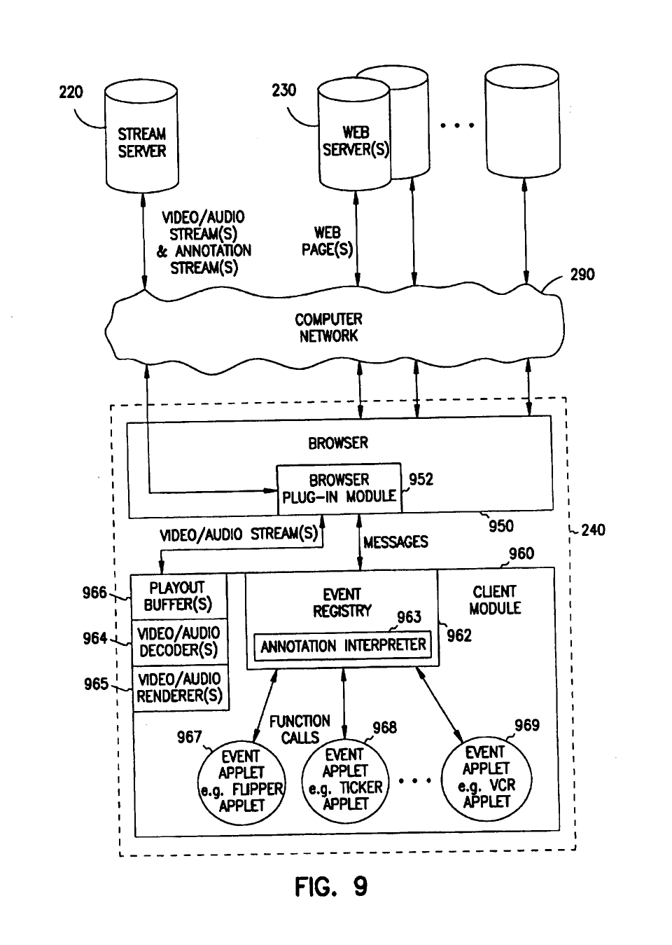

Referring now to FIG. 9, in one embodiment of the present invention, client computer 240 includes a web browser 950 and a browser plug-in module 952 for interfacing web browser 950 with a main client module 960. Client module 960 includes an event registry 962, playout buffer(s) 966, video/audio decoder(s) 964, video/audio renderer(s) 965 and one or more dynamically loadable event applet(s), e.g., flipper applet 967, ticker applet 968 and VCR applet 969. In this embodiment, event registry 962 also functions as an annotation interpreter 963.

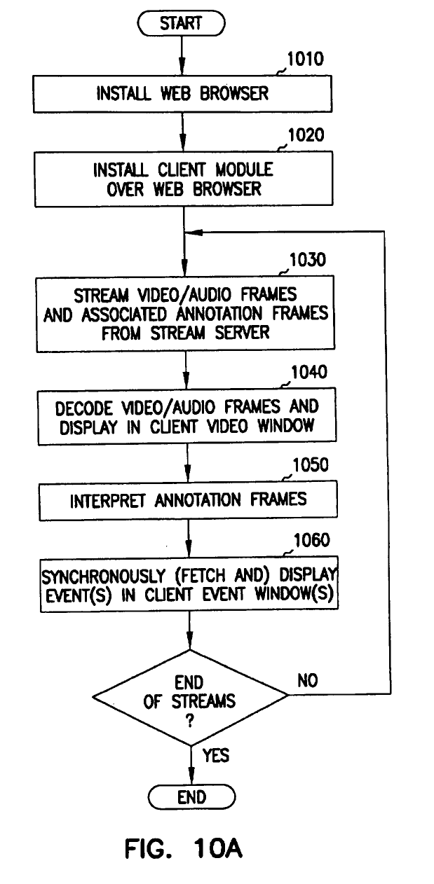

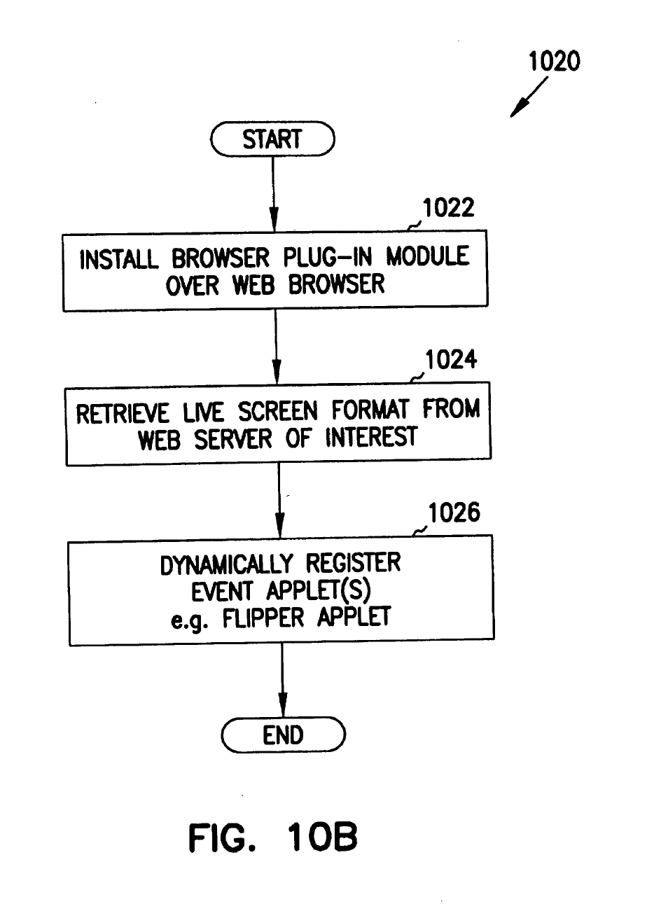

FIG. 10a is a flowchart illustrating the operation of client module 960. Assume that viewer 249 has not previously loaded client module 960 in client computer 240, but has already loaded a web browser 950, e.g., Netscape's Navigator (step 1010). Viewer 249 surfs the worldwide web (www) via the Internet and locates a web site of interest to viewer 249. Typically, the web site of interest is hosted on web server 230. Accordingly, a target web page is downloaded from web server 230 and displayed on client computer 240.

The target web page includes a link to a customized LiveScreen display, e.g., display 600. If client module 960 has not been previously loaded, client module 960 is now loaded over web browser 950 for processing video/audio and annotation streams (step 1020). Depending on the implementation, a copy of client module 960 may be available from the web site of interest. Alternatively, the target web page may provide a HTML link to another web server which has an updated copy of client module 960.

Referring now to FIG. 10b, first, browser plug-in module 952 is installed over web browser 950 (step 1022). As discussed above, plug-in module 952 provides the interface between client module 960 and web browser 950. The target web page provides a HTML link to the format for LiveScreen display 600. The LiveScreen display format is retrieved and display 600 is installed on client computer 240 using web browser 950 (step 1024).

Next, event registry 962 begins a registration/load process of the event applets, e.g., flipper applet 967, ticker applet 968 and VCR applet 969 (step 1026). Event registry 962 is capable of dynamically registering event applets, i.e., registry 962 is capable of registering additional event applets after the initial registration process, thereby making it possible to add new event windows to LiveScreen display 600 of client computer 240 without having to re-install client module 960. Each event applet has a tag which includes attributes such as Java class, command stream format RTP://server name and file name (location of stream). During the registration process, each applet provides event registry 962 with a list of its respective function(s). Appendix B includes detailed instructions for interfacing event applets, coded in Java, with browser plug-in module 952.

Referring back to FIG. 10a, encoded video/audio frames and associated annotation frames are streamed from stream server 220 to client computer 240 for synchronous display (step 1030). Streaming video and audio streams over a network is very efficient because streaming eliminates the need for a large buffer at client computer 240. In addition, streaming also provides flexibility, e.g., switching video sources midstream is possible without wasting network resources since streaming is based on a pseudo just-in-time (JIT) protocol and does not involve downloads of the entire video stream prior to display at client computer 240. If the underlying transmission protocol is HTTP, then video, audio and annotation packets are initially “pulled” by client computer 240 from server 220 using HTML “get” packet(s).

Next, the encoded video/audio streams are decoded by decoder 964, i.e., decompressed using a suitable technique, and then displayed at client computer 240 by renderer 965 (step 1040). (See co-pending applications VXT 702, 712 and 718).

In this implementation, annotation frames streamed from stream server 220 are encoded in Visual Basic script. As shown in FIGS. 8a and 8b, annotation streams 800a, 800b include stream headers 810a, 810b, respectively, followed by one or more annotation frames. Annotation interpreter 963 parses annotation frames in real-time in the form of messages from stream server 220, and converts the messages into a C++ function calls for the respective event applets (step 1050). In the case of flipper stream 800a, each annotation frame includes a HTML address and an event time marker. In the case of ticker stream 800b, each annotation frame includes ticker data and an event time marker. Note that an event time marker need not be identical to a corresponding video time stamp. Client computer 240 is capable of switching to a new displayable event together with a video frame or in between two video frames.

While the contents of annotation frames may differ, from the perspective of stream streamer 220, the event data or event locator are simply arguments to be passed on to client computer 240 to be processed by client computer 240. Hence, all annotation frames are processed in the same manner by stream server 220, i.e., annotation frames are streamed to client computer 240 at the appropriate time in accordance with their respective event time markers.

Further, since the video and annotation streams are handled synchronously but separately by video decoder 964 and annotation interpreter 963, respectively, steps 1040 and 1050 can occur concurrently or consecutively. As discussed above, event registry 962 is capable of dynamic registration of event applets. Accordingly, annotation interpreter 963 is adaptable, and capable of automatic installation and linking of new event applet(s) to add new class(es) of displayable events for client computer 240.

After registering with event registry 962, flipper applet 967 provides the location of the flipper stream to browser 950 which then begin receiving the flipper steam from stream server 220. Flipper annotation frames are provided by stream server 220 synchronously with the video/audio frames to client module 960 so that the annotations, i.e., displayable events can be synchronized for display at client computer 240 (step 1060). In this example, URL addresses, for synchronizing HTML page flips with video stream are provided to web browser 950 thereby permitting client computer 240 to subsequently retrieve and display various textual and graphical elements changing at predetermined points corresponding to the timeline of the video stream. Note that HTML pages can be retrieved from one or more web server(s) 230.

Similarly, after registering with event registry 962, ticker (tape) applet 968 provides the location of the ticker stream to browser 950 which then begins receiving the ticker stream from stream server 220. Ticker annotation frames are provided by stream server 220 synchronously with the video/audio frames so that the annotations, i.e., displayable ticker data can be synchronized for display at client computer 240 at predetermined points corresponding to the timeline of the video stream.

Many types and combinations of display windows and/or content are possible. For example, another window may be used to display documents delivered via a data annotation stream and a “PowerPoint” viewer. Another exemplary variation includes providing an annotation stream to an “ActiveX” object for viewing displayable event(s) associated with a HTML page.

After registration, VCR control applet 969 provides VCR-like control buttons 620 such as play, rewind, fast-forward, pause, and live-play. Note that since VCR buttons are under the interactive control of viewer 249, activation points in the time line cannot be predicted in advance, and so no annotation stream is used. (See co-pending application VXT 704) Instead, when a VCR-type function such as rewind (“REW”) is activated, VCR applet 969 sends an appropriate message to stream server 220, which resets both the video/audio streams and annotation stream(s) to the viewer selected point in time.

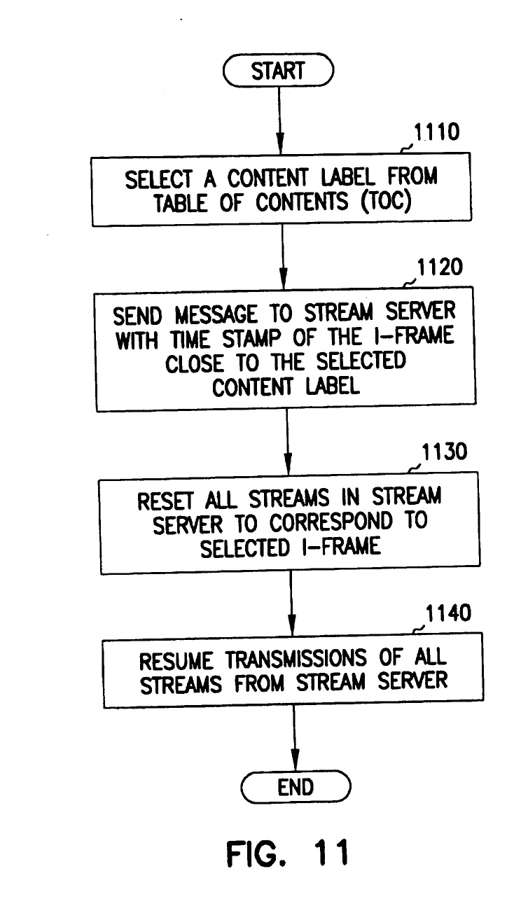

As shown in FIG. 11, a table of content 630 with content labels enables viewer 249 to skip forward or backward to predetermined locations in the video/audio stream. First, viewer 249 selects a content label of interest (step 1110). Examples of suitable content labels are section headings of the video stream. Next, client module 960 sends a message to stream server 220 with the time stamp of an I-frame from the video stream whose location is close to selected content label (step 1120). In this embodiment, an I-frame is a video frame which includes data for a complete video frame. Although computationally more intensive, it is also possible to select a P-frame and then reconstructed a complete video starting from a neighboring I-frame close to the selected P-frame.

In step 1130, stream server 220 resets the video/audio stream and the annotation stream(s) to correspond to the selected I-frame. Stream server 220 is now ready to resume transmission of the video/audio stream and the annotation stream(s) to client computer 240 for viewing (step 1140).

The present invention may be practiced with network performance improvement techniques such as dynamic bandwidth switching and selective retransmission. (See co-pending application VXT 706 and 711) Other techniques include additive layers with increasing transmission/retransmission priority, allowing client computer 240 to drop higher resolution/frame rate information which have been assigned lower priority (see VXT 603).

With the aforesaid by way of a technical introduction of the background technology, the present invention is directed to a system which provides a series of modules which can be added to a system of the type discussed above in FIGS. 1 to 11 for creating quizzes, polling and other edited features for end users and which can be stored and accessed via a remote hosted component. The modules provide for the ability of data regarding usage to be tracked and stored. The invention thus in its broadest embodiment comprises both a down loadable module 1400 and a hosted component 1500.

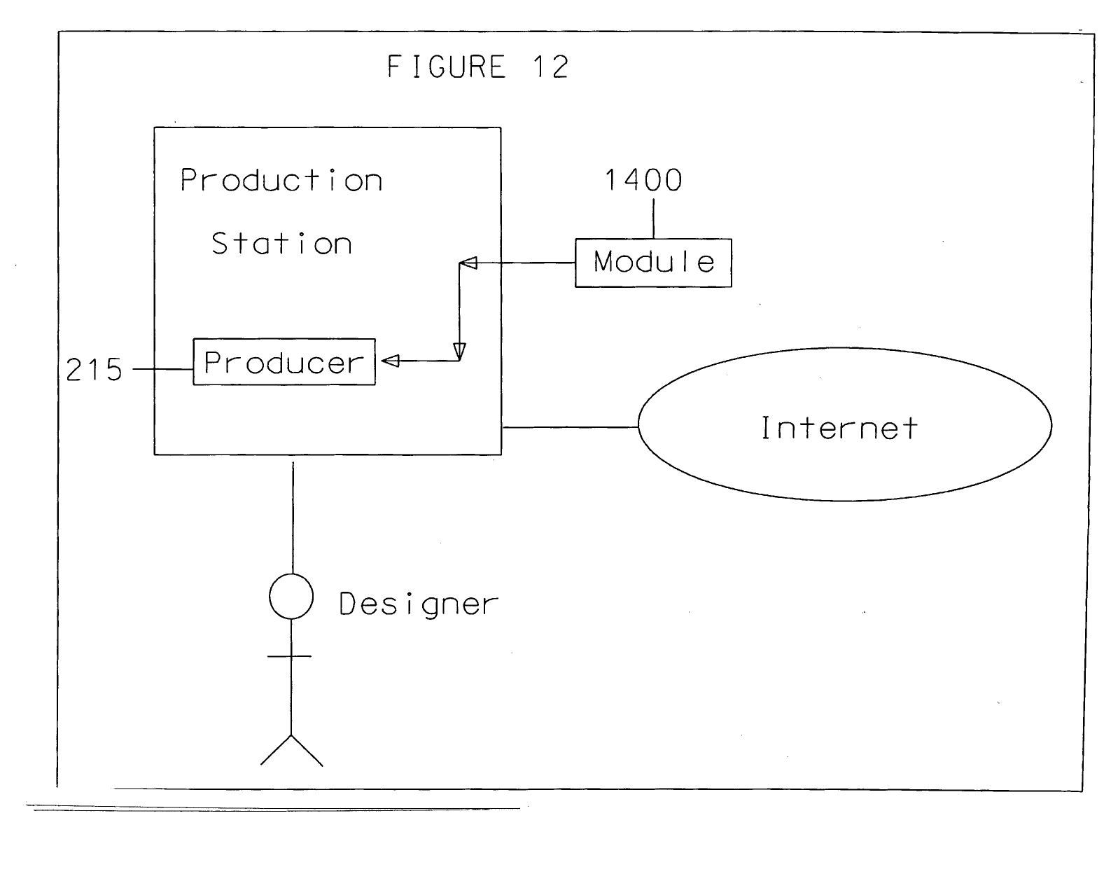

Referring to FIG. 12, the downloadable nodule 1400 produces and deploys a multi-media presentation in combination with a system of the type described above in FIGS. 1-11. As shown in FIG. 12, the invention comprises an authoring and production system such as is discussed above with a system further comprising module 1400 which provides for the addition and presentation of polling, quizzes and the addition of URL links. The system also functions with an end user who has access to a presentation outlined via Producer application and 215 module 1400.

The authoring module creates/edits polls and quizzes on a server and using the respective applications and the above system processes set forth and described with reference to FIGS. 1 to 11. The down loadable module 1400 enables the synchronization to producer active server page references (the “links”) that point to specific polls and quizzes. The system facilitates the insertion and addition of a special PowerPoint slide for polls, quizzes and URL flips (i.e., a web page) that can be added to the producer timeline as a slide.

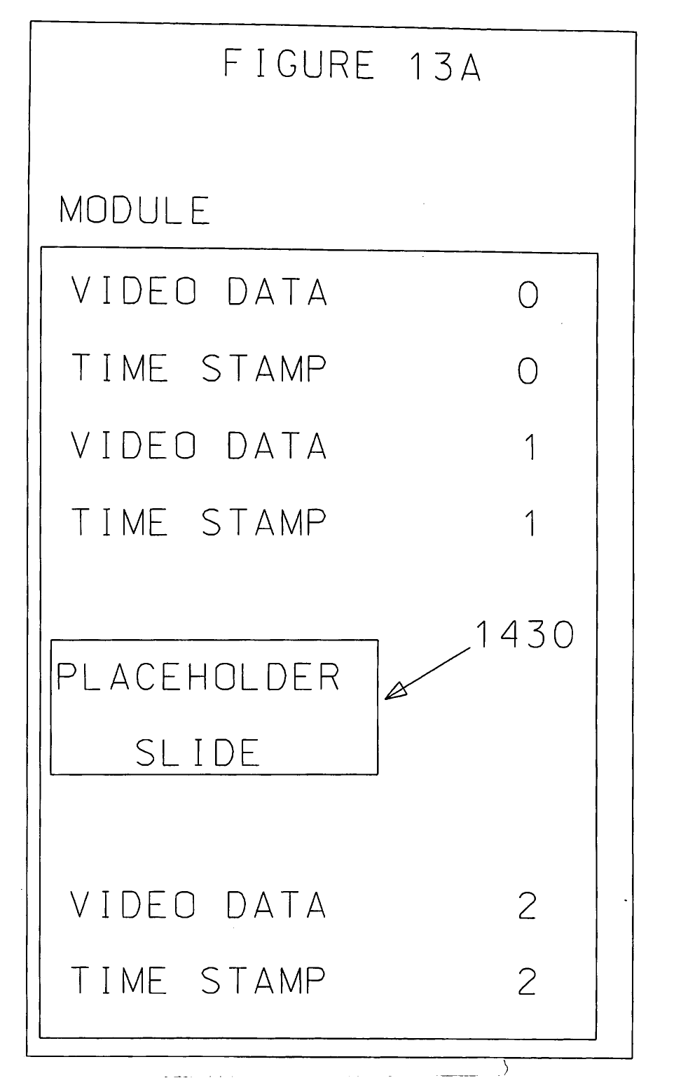

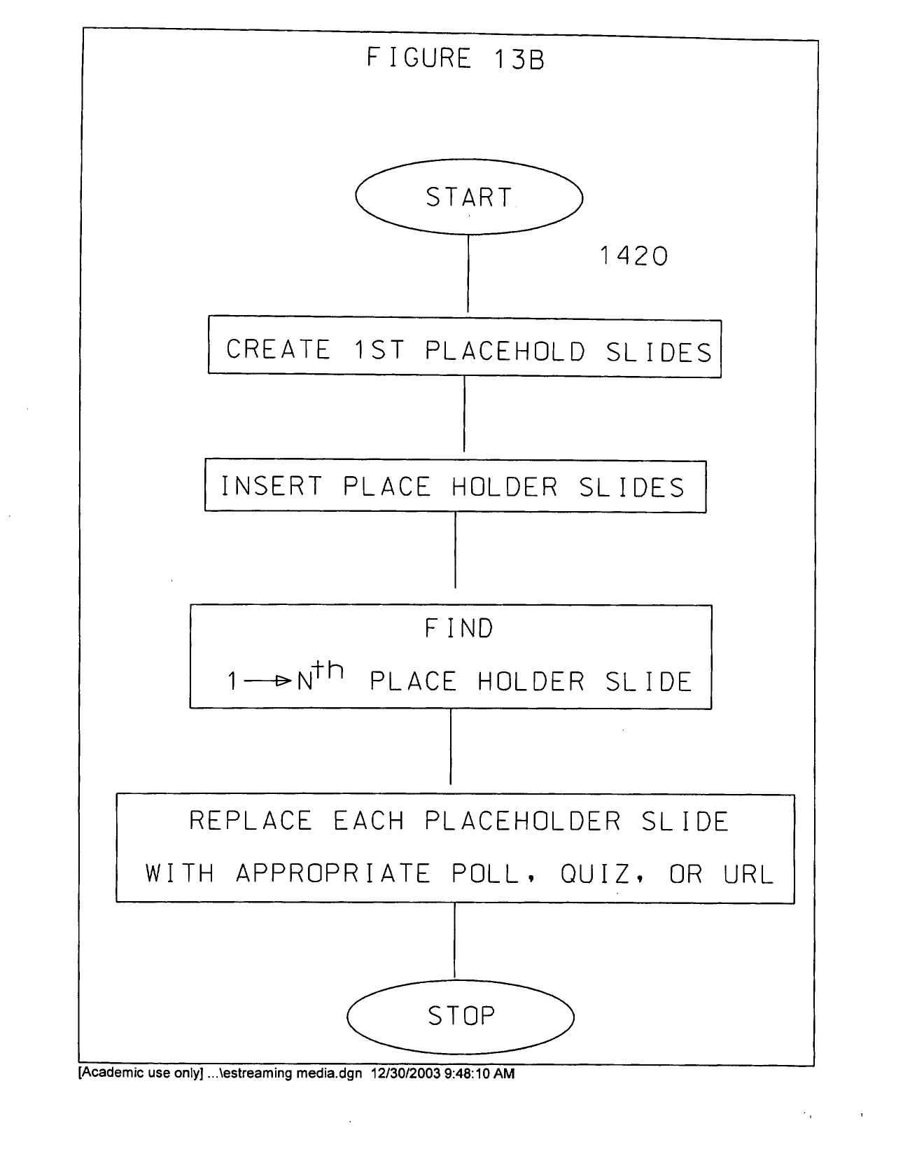

Referring to FIGS. 13a and 13b, the module 1400 creates placeholder slides 1420 which are inserted with the video data. In operation, the module replaces the slide with the respective poll, quiz or URL to be inserted. In the case of a poll or quiz, the module 1400 pauses the presentation and will resume the presentation when the end user either clicks the resume button displayed with the poll or quiz results or the resume icon associated with the media player.

The present invention provides a high level of access control. The author controls the level of access to content and the length that content is available. Moreover, the tracking feature provides an instruction with the ability to monitor these parts of the content the end user actually watched. This is important for monitoring the effectiveness of the content.

In addition to password protection, content can be encrypted to prevent piracy. Applications cannot be copied and passwords cannot be shared or broken. The system permits the creation of a knowledge base or library of content.

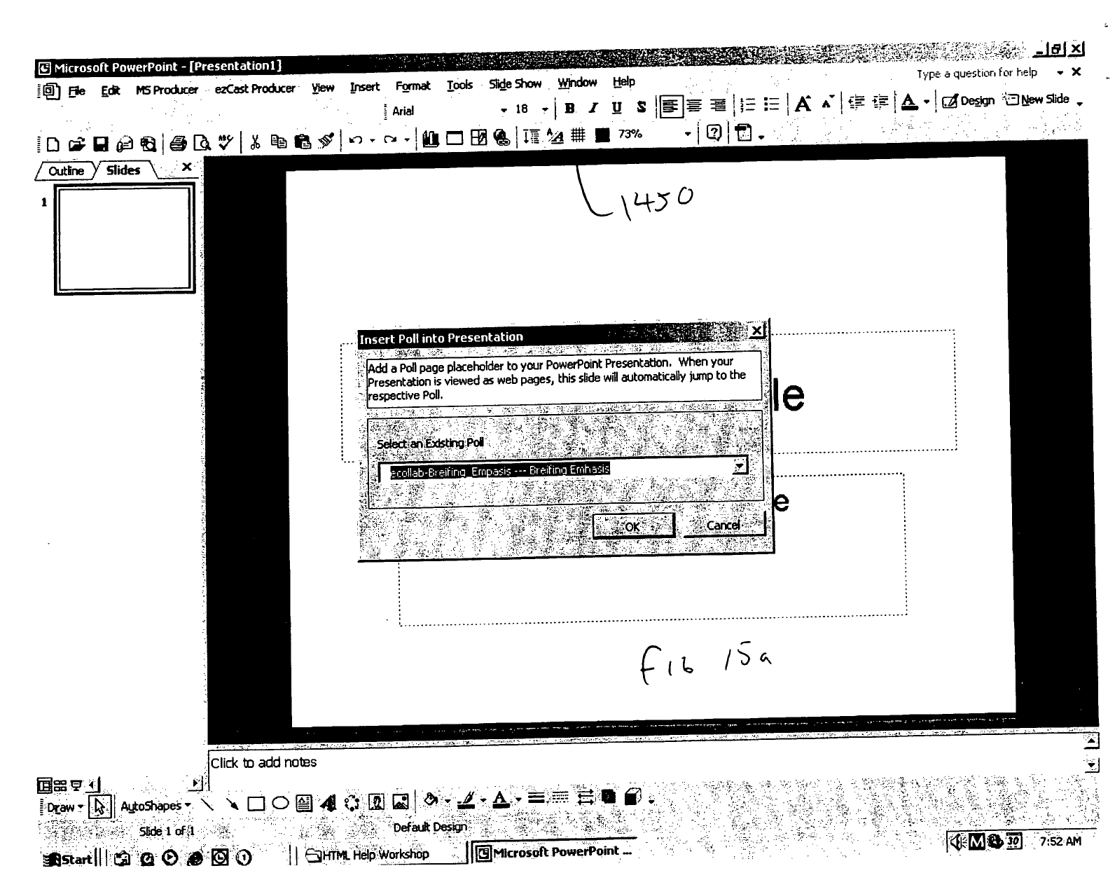

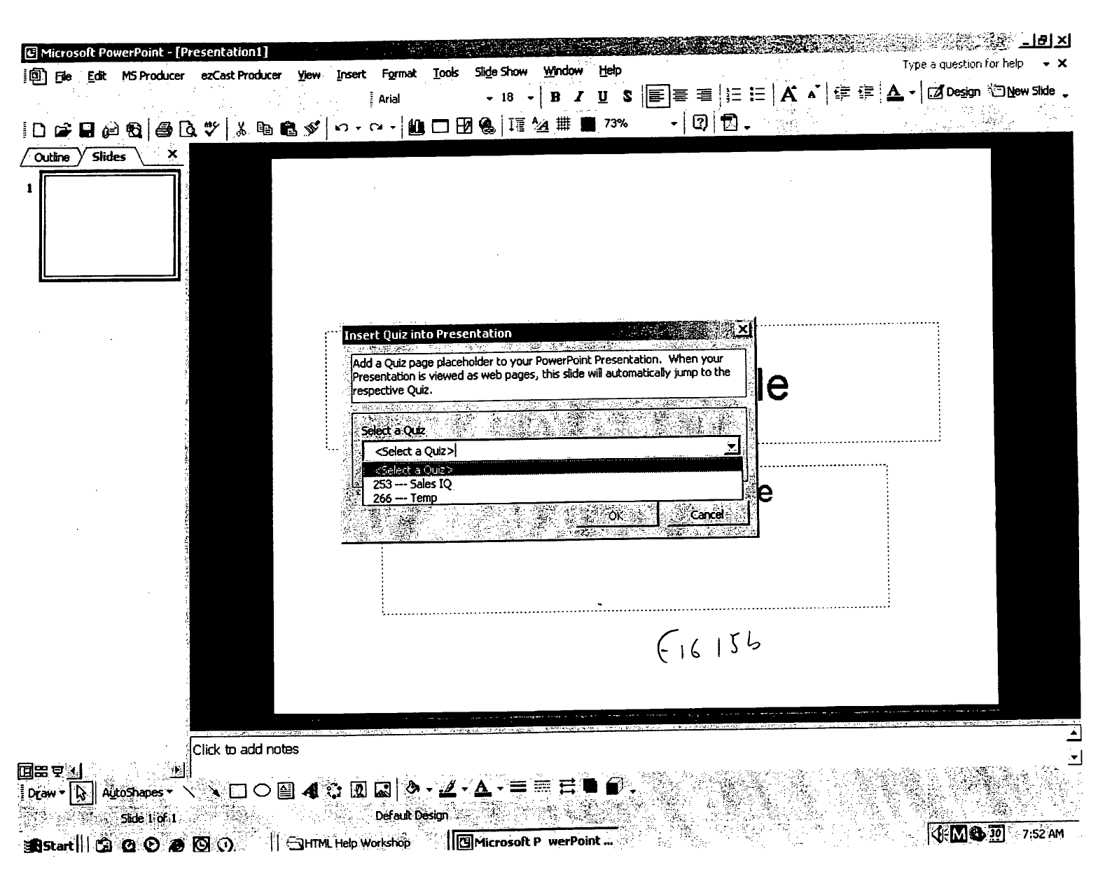

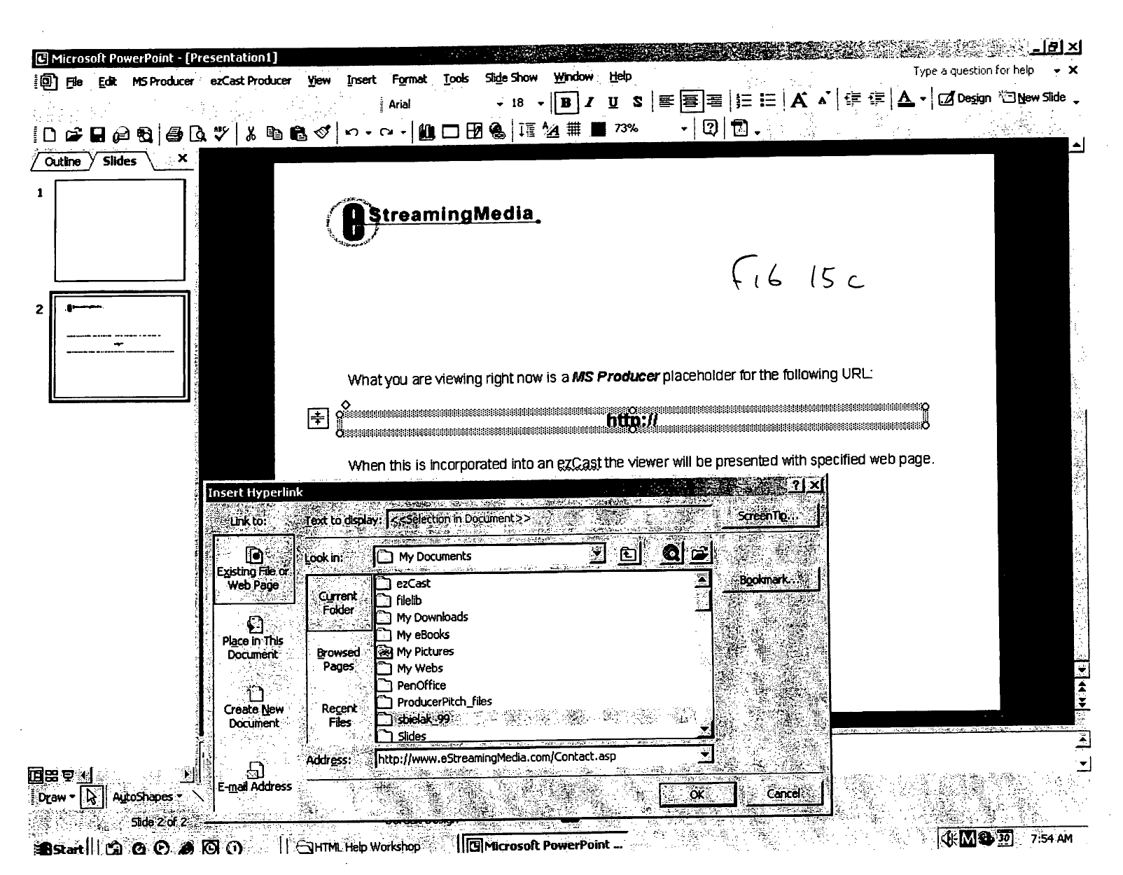

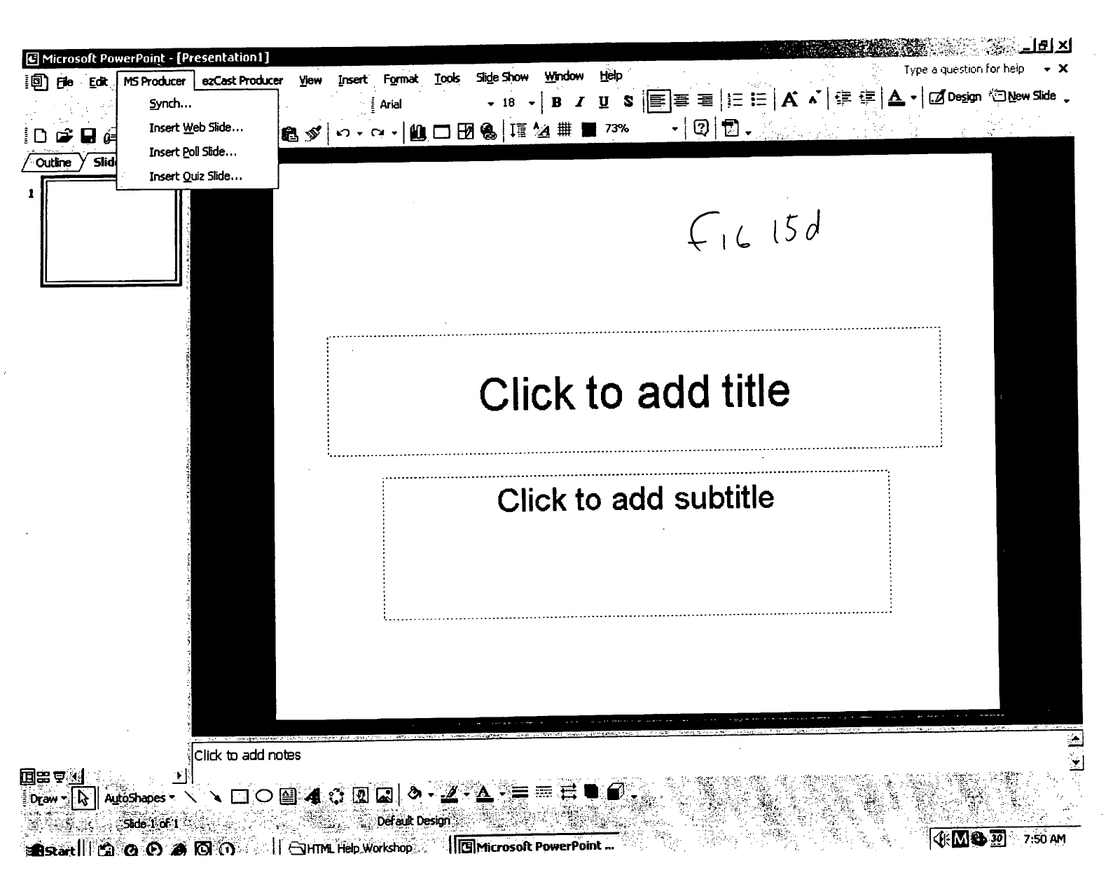

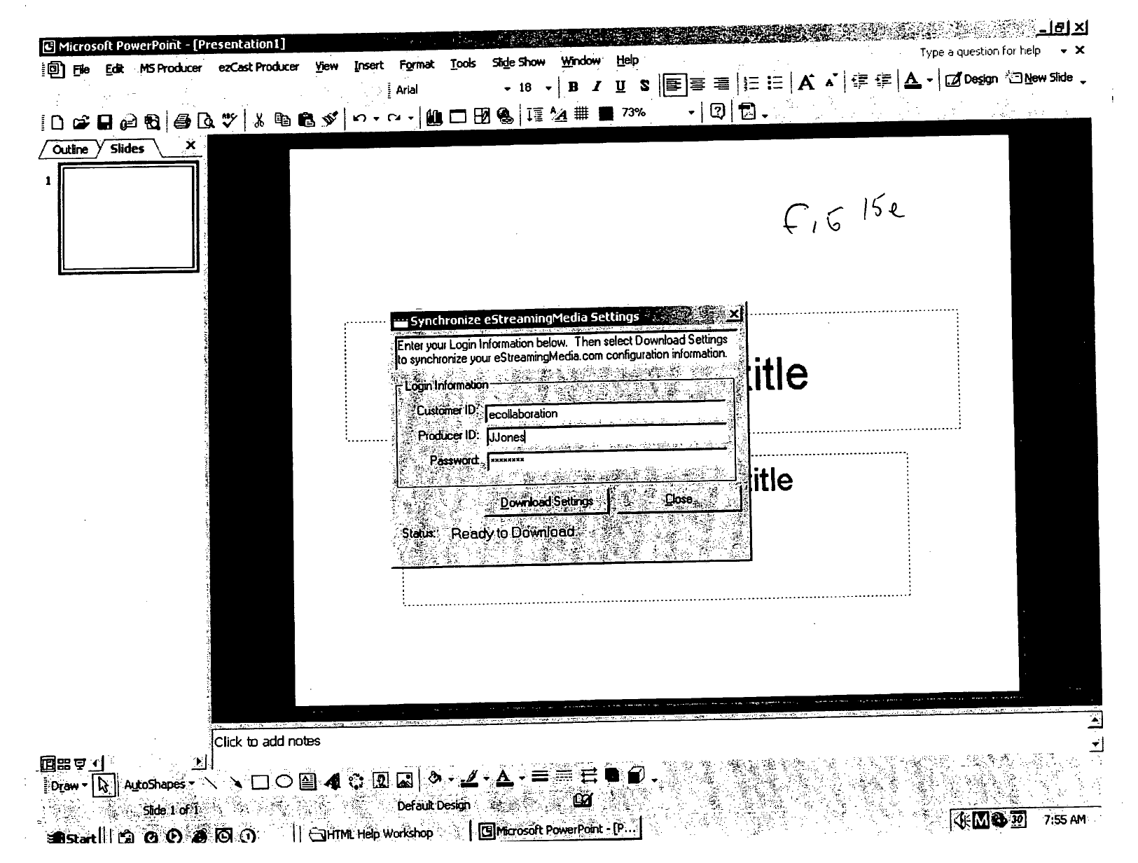

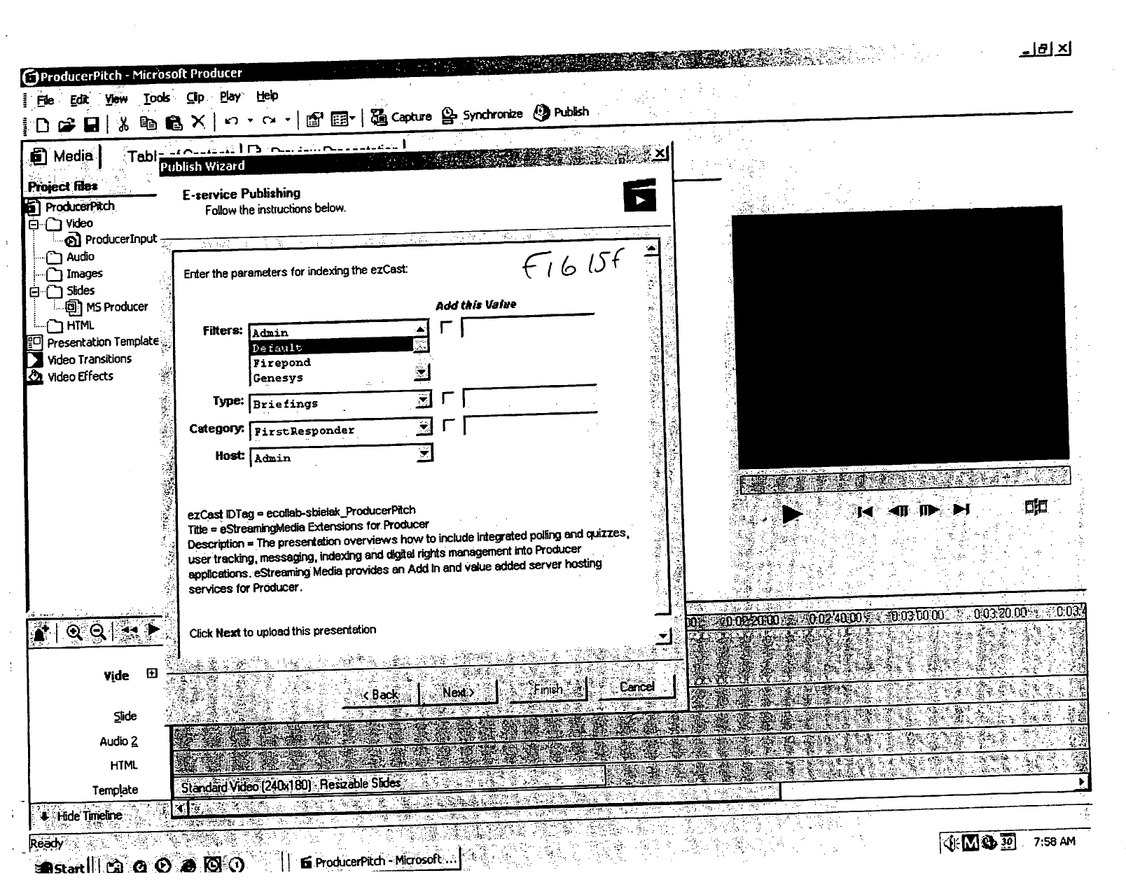

The Authoring Interface 1450 shown in FIGS. 15a-15f which shows the screens a user would go through in creating a presentation. In general the User Interface creates polls and quizzes by logging on to the service and using the appropriate page. In the context of Microsoft PowerPoint, the author user would open PowerPoint and use the service menu (the add in) to synchronize links to Polls and Quizzes that are available on the server. The producer or creator could then insert Polls, Quizzes or URL flips, by using the menu in PowerPoint. In an example of a Poll or Quiz, the Designer may be presented with a list of available Polls or Quizzes, pre-stored on the system. In the case of a URL, the Designer may be presented with a web search dialog in which to insert URLs. The producer would insert these in the placeholder slides.

Referring specifically to FIGS. 15a to 15f, the series of authoring screens are shown. FIG. 15a illustrates an authoring screen which permits the addition of a poll into a presentation. FIG. 15b illustrates a system for inserting a quiz into a presentation. As shown, the system provided a number of pre-stored quizzes as noted above.

FIGS. 15c and 15d illustrates a hyperlink insertion (i.e., URL) tool. FIG. 15e illustrates a screen for synchronizing the inserted web slide, poll slide or quiz slide in a presentation screen. FIG. 15 illustrates a publishing tool.

The input screens thus include a menu screen that enables producers to include polls, quizzes or other web pages as a slide. First, the system will synchronize (e.g., download) links or settings. This may comprise a VB module that logs on to the system, queries the database for available polls and quizzes and creates a local XML file of links. The Insert Poll, Quiz or URL function copies a respective predefined slide and inserts the link as meta data. For example, a poll slide may have the following meta data inserted:
<meta name=Description content=“Jun. 2, 2003: Poll Flip: ecollab-MSProd1—MS Producer Poll1”>

Where ecollab-MSProd1 is a unique poll identifier and MS Producer Poll1 is its user-friendly name.

When the poll slide is opened as a web page in the presentation, a script searches the meta data and determines the appropriate redirect and pauses the presentation in the event of a poll or quiz using the following scripting:

```
if(getIDTag(“Poll Flip:”).length > 0)
    {
    document.location.href = “http://www.ecollaboration.net/ep.asp?P=”
    getIDTag(“Poll Flip:”)
    parent.MediaPlayer_Pause( )
    }
else if(getIDTag(“URL Flip:”).length > 0)
    {
    document.location.href = getIDTag(“URL Flip:”)
    }
else if(getIDTag(“Quiz Flip:”).length > 0)
    {
    document.location href
    “http://www.ecollaboration.net/quizzes/QuizWriter.asp?QuizID=”
    +getIDTag(“Quiz Flip:”) +“&UserID= ”
    parent.MediaPlayer_Pause( )
    }
    }
        catch(e){ }
```

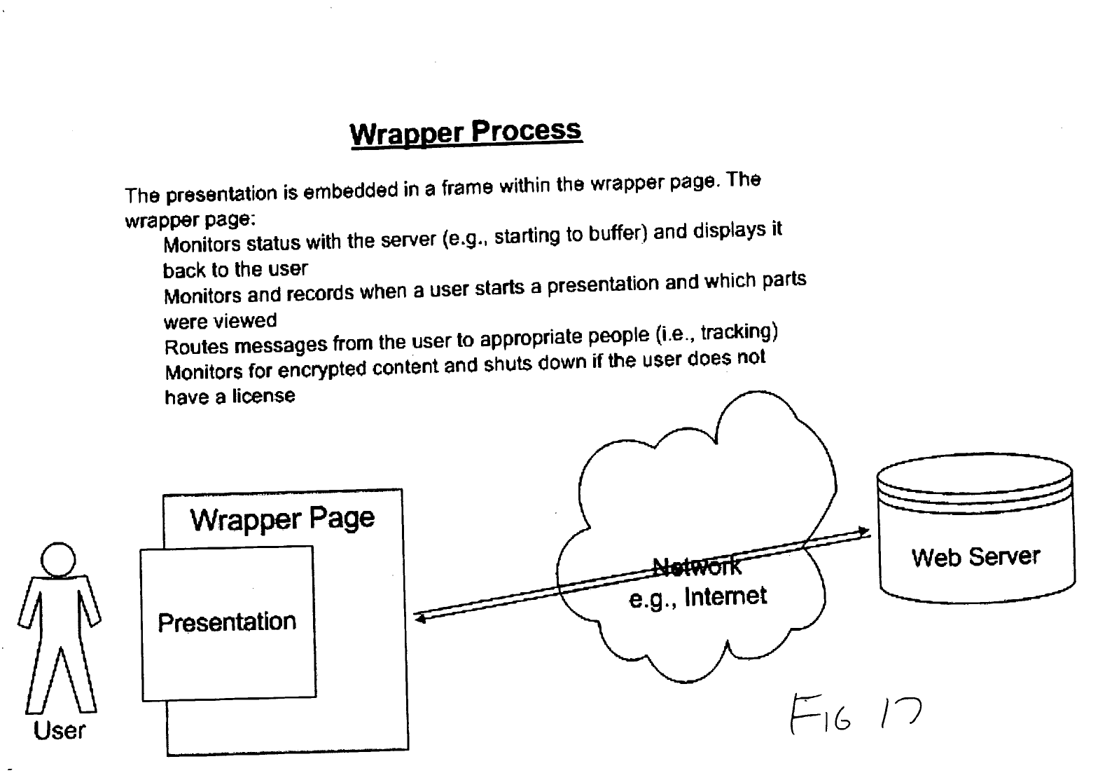

Referring to FIG. 17, the slide show presentation is run within a frame of the wrapper active server page. The wrapper page contains the logic for usage tracking and messaging. The wrapper page:
1) Monitors the status with the server (e.g., starting to buffer) and displays it back to the user;
2) Monitors and records when a user starts a presentation and which parts were viewed;
3) Routes messages from the user to appropriate people (i.e., tracking); and
4) Monitors for encrypted content and shuts down if the user does not have a license.

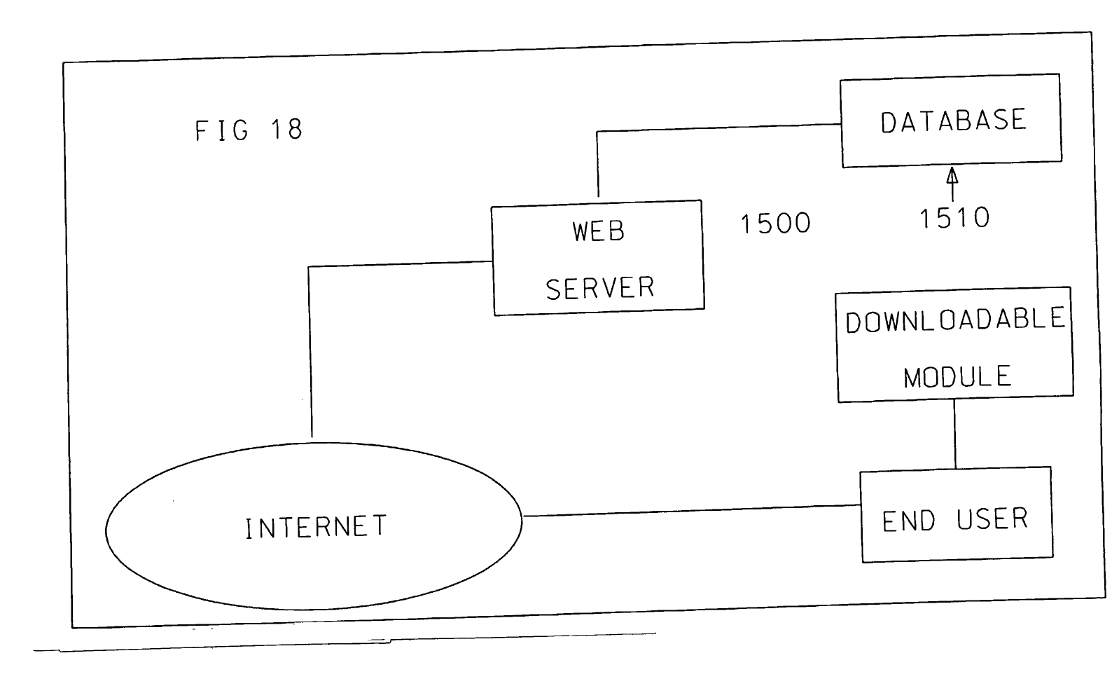

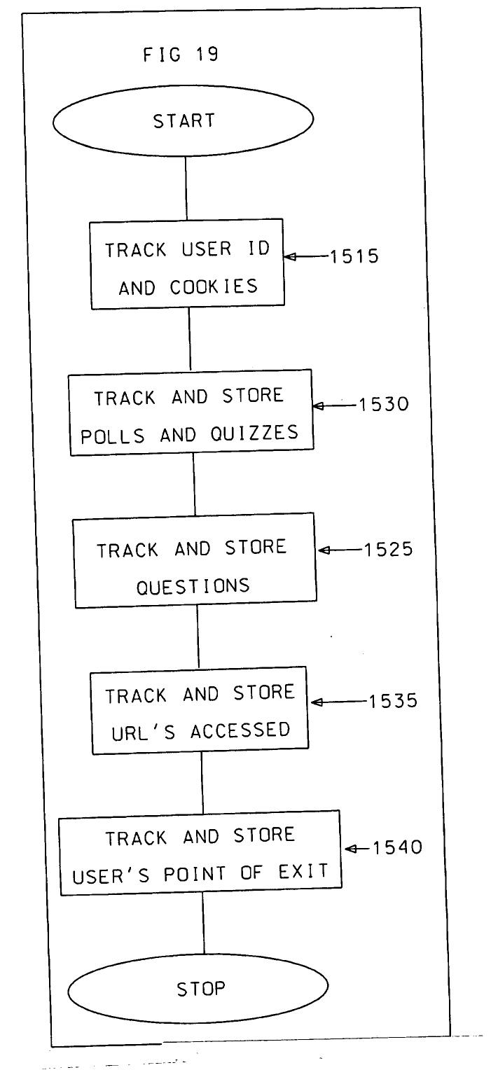

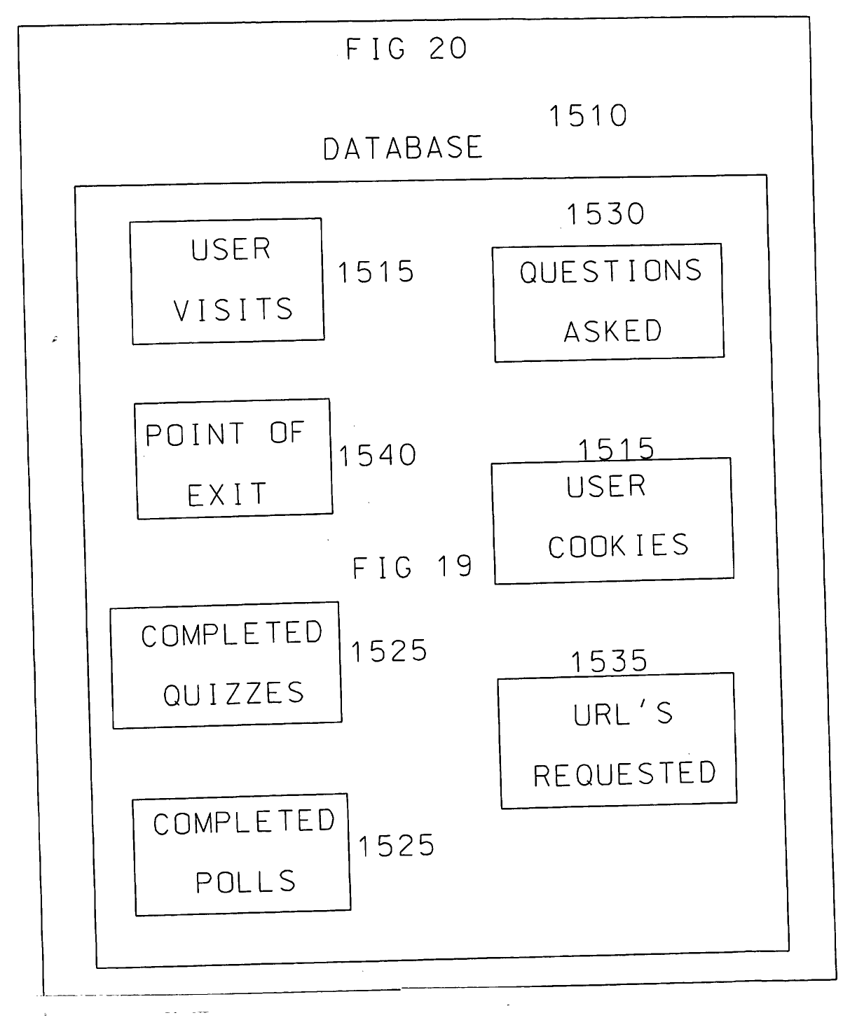

Referring to FIGS. 18-20, a further feature of the invention is the hosted component 1500. Once the presentation is created, this aspect of the invention enables published page indexing and tracking via a database 1510. The invention uses a server to encrypt content and issue licenses and to monitor usage of the system. The system 1500 includes software to track the identity of users, what did they get, provide user feedback for polls, responses and quiz results.

Referring to FIG. 20, the remote server 1500 and database 1510 tracks usage of each presentation through a unique user identifier 1515 that's placed on the user's machine as a cookie 1515. (While the server can generate a unique GUID, it also picks up an identifier from a calling application—e.g., a log on from a corporate system). The server checks for a GUID cookie, and will create and download a new one if it is not present whenever a user accesses the server. The correlation of a person to a GUID occurs when a user registers (i.e., identify themselves by providing their email address and name).

The server 1500 records and stress in a database when a person exits the presentation (i.e., the current position in the clip) 1520, enters a question or comment during the presentation (i.e., uses a message box) 1525 and also when he or she completes a poll or a quiz 1530. The server tracks usage of people that use the system and accounts for the possibility that end users use different machines. For example, if an end user uses the submit box on a second PC that they have not registered, the server will prompt the end user to complete registration and consolidate all activity using that person's email address or other identifier. The server tracks URLs accessed 1535 and the User's point of exit 1540.

In use, the application polls the media player within the producer application for the current position in the clip. When the application closes, it writes an entry to log table that contains the GUID, any user information, the ID of the presentation, the current position (last position) and duration.

A critical feature of the invention is the inclusion of indexing, and user tracking criteria, and other data that is collected from the server database and which copies the wrapper program (i.e., the parent program) into the publishing folders (This is due to a limitation that the wrapper program must be in the same folder as a presentation files for the application to function properly). When the publishing asp page is loaded it automatically submits a form whose target is a hidden iFrame within the publishing wizard.

The form acts as an asp page that collects publishing criteria and other data from the database and writes them to the hidden iFrame. The publisher can then select from these indexes or add new ones in the publishing function.

Code added for the log on and collecting data:

<form name=init target =“info” onsubmit=“logErr.innerHTML =
‘<BR><b>Click
Next to Validate and Continue</b>’” action=“GetInfo.asp”>
<!-- These two TEXT elements retrieve the property values. →
CustomerID:&nbsp;&nbsp;<INPUT ID = “CustomerID” NAME =
“CustomerID” size=“20”><BR>
ProducerID:&nbsp;&nbsp; <INPUT ID = “HostID” NAME = “HostID”
size=“20”><BR>
Password:&nbsp;&nbsp;&nbsp;&nbsp;<INPUT TYPE = “Password” ID =
“PWD” NAME = “PWD” size=“20”><BR>

The response code:

response.write “<input type=‘hidden’ name=‘valid’ value=‘TRUE’ >”
response.write “<input type=‘hidden’ name=‘prefix’ value’” &
strCustomerPrefix & ’” >”
response.write “<input type=‘hidden’ name=‘logon’ value=’” &
strLOgOn & ’” >”
response.write “<input type=‘hidden’ name=‘pwd’ value=’” &
strPWD & ’” >
response.write “<input type=‘hidden’ name=‘ProdFolder’ value=’” &
strFolder &’”>”
response.write “<input type=‘hidden’ name=‘ASFFolder’ value=’” &
strASF &’”>”
response.write “<input type=‘hidden’ name=‘PlayFolder’ value=’” &
strPlay &’”>”
response.write “<input type=‘hidden’ name=‘customerid’ value=’” &
strCustomerID &’”>”
response.write “<input type=‘hidden’ name=‘hostid’ value=’” &
intHostID &’”>”
response.write strFilterSelect
response.write strCategorySelect
response.write strTypeSelect
response.write strHostSELECT

The last four writes are formatted list boxes containing the data. The publishing page then copies them from the hidden iFrame “info” to the publishing page.

| function setCombos( ) | |
|---|---|
| { | |
| cboFilter.innerHTML | = info.selFilter.outerHTML |
| cboType.innerHTML | = info.selType.outerHTML |
| cboCategory.innerHTML | = info.selCategory.outerHTML |
| cboHost.innerHTML | = info.selHost.outerHTML } |

To mitigate maintenance of the wrapper program, the actual wrapper need not be copied, instead a file with an include statement for the wrapper is copied. This allows a change to the main wrapper program to be migrated to all of the folders.

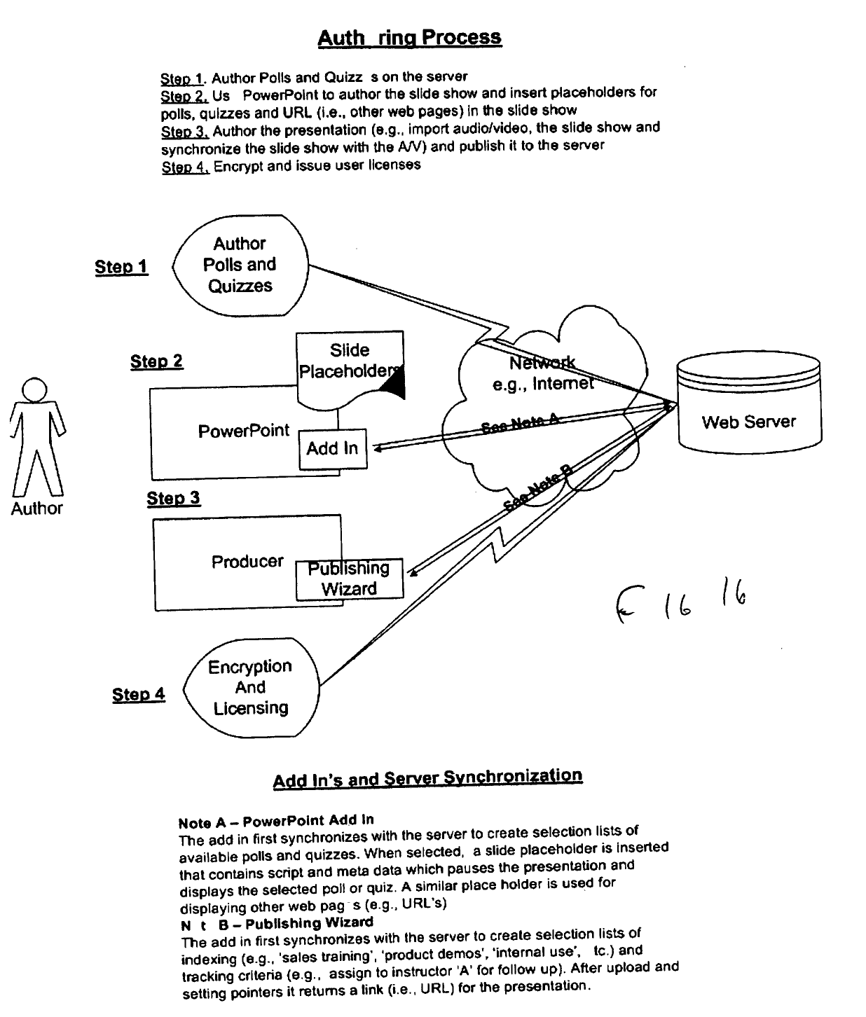

To summarize, and as shown in FIG. 16, the Authoring Process is shown and described as follows: In a first step, the author creates polls and quizzes on the server. The author uses a program such as PowerPoint to author the slide show and insert placeholders for polls, quizzes and URL (i.e., other web pages) in the slide show. Next, the author creates the presentation (e.g., import audio/video, the slide show and synchronize the slide show with the A/V), and publishes it to the server. Finally, they encrypt and issue user licenses.

As shown, in FIG. 16, a PowerPoint add-in first synchronizes with the server to create selection lists of available polls and quizzes. When selected, a slide placeholder is inserted that contains script and meta data which pauses the presentation and displays the selected poll or quiz. A similar placeholder is used for displaying other web pages (e.g., URL's).

As further shown in FIG. 16, a publishing add-in synchronizes with the server to create selection lists of indexing (e.g., “sales training”, “product demos”, internal use”, etc.) and tracking criteria (e.g., assign to instructor “A” for follow-up). After upload and setting pointers it returns a link (i.e., URL) for the presentation.

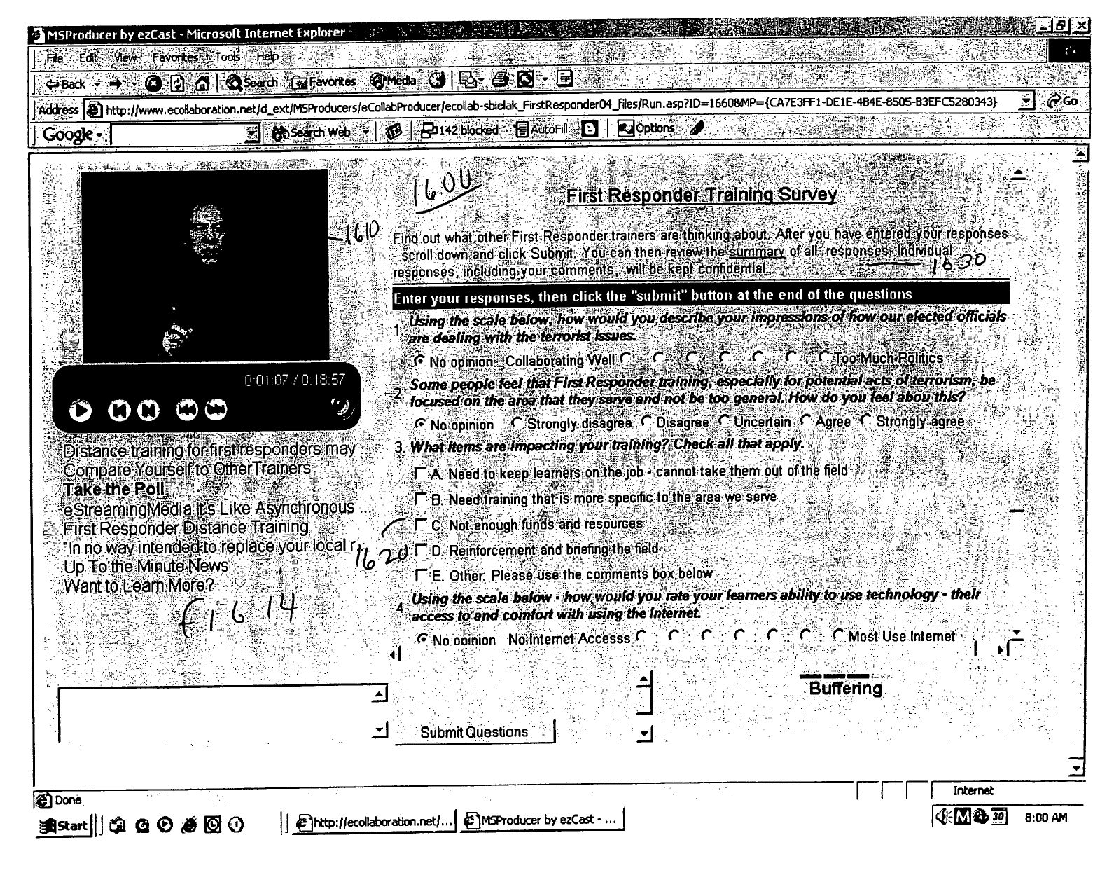

Referring to FIG. 14, the end user screen 1600 is shown. This is the screen used by an end user to view the presentation. As shown, the screen presentation provides a multi-media presentation 1610 and includes a poll 1620. For example, in addition to asking each user to answer polling questions, the system permits the end user to see the poll results, a summary of how all the respondents answered—and how answers compare to others 1630. The invention envisions an instructor led class where the instructor ask the class questions and everyone can listen to and compare their answers.

The present invention is designed and intended to be utilized in conjunction with a website and web application which permits end users to access a website and web application. The web-based application will store a number of presentations. End users can access the presentations and, based upon a pre-selected level of access, view the presentations.

The present invention has been described with reference to the enclosed Figures and above detailed description. It is to be appreciated that the true nature and scope of the present is to be determined with reference to the claims appended hereto.

1. A computer system for creating a presentation containing interactive media such as polls or quizzes.
taking a video stream including a plurality of video frames, each said video frame including a time stamp; and sequentially displaying said video frames on said display device, starting from an initial video frame of said video stream;
adding additional placeholder slides corresponding to user polls, quizzes or website links accessible via a remote server; and
uploading the presentation into the remote server which is accessible to end-users.

2. A method for playing a presentation including polls or quizzes comprising:
receiving a presentation in from a remote server;
sequentially playing the frames, starting from an initial frame of the stream of data;
selecting from a table of contents being displayed on a display device of a local computer, content related to a poll or quiz to be accessed by the end user;
The method of claim 2 further comprising the step of storing the quiz or poll results for further analysis.

3. A method communicates with presentation program and the server when the presentation is viewed.
communicating the request for poll or quiz to the remote server; receiving the stream of data from the server, related to the poll or quiz; responding to the poll or quiz at the local by the end user and uploading the poll or quiz results on the remote server
displaying status messages of the communications with the server to the user monitoring and recording usage of when each user exits a presentation routing user messages to appropriate people
automatic program shutdown if the user attempts to play an encrypted presentation if they do not have an authorized license.

4. A method for publishing and deploying presentations collecting indexing and other data from a server database and displaying it to the presentation's author
creating indexes for users to look up presentations based on content an authoring log-on that validates authors

5. A method for hosting presentations
user tracking and monitoring
indexing for users to look up select presentations
encrypting presentation content and deploying licenses for viewing protected content
